(19) United States
(12) Patent Application Publication
(10) Pub. No.: US 2025/0160339 A1
(43) Pub. Date: May 22, 2025

(54) SUPPLEMENT STIMULATING ROOT SYSTEM OF PLANTS IN TIMES OF CLIMATE CHANGES

(71) Applicant: MANEKO, spol. s.r.o., Suchdol (CZ)

(72) Inventor: Jan SCHULMANN, Suchdol (CZ)

(73) Assignee: MANEKO, spol. s.r.o., Suchdol (CZ)

(21) Appl. No.: 18/836,198

(22) PCT Filed: Mar. 4, 2023
(86) PCT No.: PCT/IB2023/052034

§ 371 Date: Aug. 6, 2024

(30) Foreign Application Priority Data
Mar. 25, 2022 (CZ) PV 2022-135

(51) Int. Cl. A01N 63/50; A01N 63/20; A01P 21/00; C05G 3/80

(52) U.S. Cl. CPC A01N 63/50; A01N 63/20; A01P 21/00; C05G 3/80

(57) ABSTRACT

The supplement containing up to 100 wt % of depolymerised residue after dry distillation of wood at a temperature of up to 300° C. is used to enrich the soil layer to a depth of 5 to 30 cm or when planting trees and shrubs to a depth according to the size of the root ball, with 0.5 to 9.9 wt % of depolymerised residue after dry distillation of wood at a temperature not exceeding 300° C. in relation to the weight of soil. In addition the supplement may contain up to 90 wt % of at least one substance selected from a group consisting of compost, organic fertiliser, inorganic fertilisers, minerals, bacterial cultures of aerobic micro-organisms, carbohydrate-based bacterial nutrients, cellulase and amylase, in relation to supplement weight.

### TECHNICAL FIELD

In recent years, we have seen an increasingly pronounced impact of climate changes, especially higher temperatures and lack of rainfall, even in previously temperate climatic areas, which fundamentally threatens the lifespan of some plant species, including agricultural commodities, and leads to a gradual deterioration in the quality of the soil itself.

### BACKGROUND ART

Known patent CZ307633 describes the reclamation of sandy soils under difficult climatic conditions. Sandy soils do not have sufficient organic matter content, so they do not retain water adequately, they are not biologically active and cultivated plants cannot make sufficient use of added fertilizers. In the case of sandy soils depolymerized residue after dry distillation of wood at temperatures up to 300° C. (so called hydrolysis lignin) has proved effective for the reclamation purposes, as this material is able to retain in those soils sufficient quantity of water.

Wood mass is a lignocellulose and hemicellulose complex in which lignin ensures woodiness of cell walls and makes up about a third of the weight of wood. Lignin is the second most common compound on Earth after cellulose, it makes up about 25% of plant biomass and occurs in the largest amount in the woody cell wall of plant cells. Lignin performs a hydrophobic function in the body of woody plants, connects intercellular fibers and thus strengthens cellulose molecules within the cell walls. Lignin lacks a regular structure, it is a mixture physically and chemically heterogeneous substances, more precisely a mixture of high-molecular polyphenolic amorphous substances and its synthesis takes place directly in the cell wall, while the basic building blocks are phenylpropanoids, especially p-coumaryl alcohol, coniferyl alcohol and sinepyl alcohol, which are covalently bound to polysaccharides. Wood mass is a renewable energy source. For many many years it has been used for the production of charcoal, which is produced by heating the wood mass without air at a temperature of 450 to 550° C. The lignocellulosic complex is gasified and carbonized to form carbon monoxide and carbon dioxide, methane, liquid and charcoal. The technology of dry distillation of wood was on a large scale used until recently to produce methanol-based aviation fuel. Heating of the wood mass without air at a temperature of 270 to 300° C. only leads to depolymerization of the lignocellulose complex and breakaway of methanol groups to form methanol, acetone and a byproduct consisting of phenylpropanoid derivatives already without alcohol groups, bound to partially depolymerized and carbonized cellulose, with a residual methyl alcohol content. This byproduct, which we will henceforth refer to collectively as depolymerized wood distillation residue at temperatures up to 300° C., has very fine granulometry, high organic carbon C_{org} content up to 50%, is able to retain several times its weight of water and is relatively difficult to dissolve in water. In the past, it was produced in tens of millions of tons and represents an environmental problem that so far has not been solved, because attempts to increase its calorific value (torefaction) and the production of fuel pellets have not been very successful until today, compared to the calorific value and the use of charcoal.

In the case of sandy soils is reclamation possible due to the ability of the depolymerized residue after dry distillation of wood at a temperature of up to 300° C. to significantly increase water retention in the soil. In times of climate changes the ability of increased water retention is also important for cultivated soils in temperate areas. We have now discovered that the depolymerized residue after the dry distillation of wood at a temperature of up to 300° C. not only has the ability to increase water retention in the soil, but in particular even in very small doses stimulates the growth of a deeper and richer root system, through the so called auxin effect.

### DISCLOSURE OF THE INVENTION

Supplement stimulating root system of plants, primarily on cultivated soils in times of climate changes, according to the invention consists in the fact that supplement containing up to 100 wt % of depolymerized residue after dry distillation of wood at a temperature of up to 300° C. is used to enrich soil layer to a depth of 5 to 30 cm or when planting trees and shrubs to a depth of the root ball, with 0.5 to 9.9 wt % of supplement in relation to the weight of soil.

The above mentioned supplement containing the depolymerised residue from dry distillation of wood at a temperature not exceeding 300° C. may also contain up to 90 wt % of at least one substance selected from a group consisting of compost, organic fertiliser, inorganic fertilisers, minerals, bacterial cultures of aerobic micro-organisms, carbohydrate-based bacterial nutrients, cellulose and amylase, in relation to the weight of the supplement.

The supplement may be incorporated into the required soil layer by standard agricultural mechanisation, or the soil surface can be overlaid with a 5 to 30 cm layer of the soil mixture with the supplement, this mixture containing 0.5 to 9.9 wt % of depolymerised residue after dry distillation of wood at a temperature not exceeding 300° C. in relation to the weight of soil.

The depolymerized residue after dry distillation of wood at temperatures up to 300° C. is an organic material with very fine granulometry, with limited water solubility. It can retain 2.8-3.4 times its weight of water, releasing it gradually depending on the quality of the soil and the temperature at the root depth. In temperate soils addition of only 1 wt % of depolymerized residue after dry distillation of wood at temperatures up to 300° C. means a significant increase in water retention by 10-20% during normal rainfall, and at root depth temperature of 20° C. this water is released for 7-9 days, at an extreme temperature of 40° C. for 2 days, and with this and with forementioned auxin effect significantly improves plant growth conditions.

Besides mentioned water retention ability the depolymerized residue after dry distillation of wood at temperatures up to 300° C. has a strong stimulating effect similar to auxins, i.e. phytohormones capable of altering the distribution of nutrients and growth rates between the root and the aboveground part, which is essential for the plant's access to water and nutrients in climatically unfavorable time periods. This fact is demonstrated for example by subsequent experiments.

We compared the growth rate of the root and the aboveground part of mustard seeds.

FIG. 1 shows “Length of the root of mustard seeds germinated in the extract from the depolymerised residue after dry distillation of wood below 300° C.” and FIG. 2 “Length of the hypocotyl (the first stem part of the germinating plant between the uterus and the root) of mustard seeds germinated in the extract from the depolymerised residue after dry distillation of wood at a temperature below 300° C.”. Both experiments show that early growth of mustard root is demonstrably higher beginning from 1 vol % of water extract from the depolymerised residue after dry distillation of wood at a temperature not exceeding 300° C. At higher concentrations, there is a more pronounced growth of the root relative to the aboveground part, which is the result of the aggregate effect of the content of depolymerized residue after dry distillation of wood at temperatures up to 300° C. and auxins on cytokinins, which are other growth stimulating phytohormones.

To test a supplement containing 100 wt % of depolymerized residue after dry distillation of wood at temperatures up to 300° C. in real soil conditions and to verify its auxin-like effect a container test of germination was carried out again with white mustard. For the test were chosen two soils with different pH taken from the topsoil horizon in agricultural fields, namely acidic cambisol (the most widespread soil type in the Czech Republic) and neutral fluvisol (alluvial soil). The container test was carried out in a greenhouse at a controlled temperature of 23/18° C. day/night. The supplement was tested on each soil in five variants, corresponding to a weight addition of 1, 5, 10, 25 and 50%, related to the weight of the soil, and each variant was implemented in five independent repetitions. 400 g of soil was weighed into each container, into which a supplement was mixed in a given amount, 15 mustard seeds were sown in each container and all containers were watered with with demineralized water. Water loss was compensated every other day after a gravimetric check. Subsequently, the number of aboveground parts was monitored at regular intervals. After 17 days, the plants were carefully removed and the length of their roots and aboveground parts measured. The results of the proportion of germinated seeds on individual soils after the addition of the supplement are shown in FIG. 3 for cambisol and FIG. 4 for fluvisol.

Germination of mustard plants on acid cambisols was generally very high on all variants. The control variant achieved a very good germination rate of 80%, but the addition of 1 wt % of the supplement significantly increased germination up to 95%.

Neutral fluvisol is less favorable in terms of germination, the control variant achieved germination of only 63% and all additions of the supplement increased germination on a significant scale in doses of 5% and higher, with germination in variants adding 10 and 25 wt % reaching about 96%.

FIG. 5 “Height of mustard plants on acid cambisols with supplement—17 days of growth” and Graph 6 “Length of mustard root on acid cambisols with addition of supplement—17 days of growth” prove that an auxin-like effect has a supplement containing 100 wt % of depolymerised residue after dry distillation of wood at temperatures below 300° C. even in soil conditions, namely in acidic cambisols. In the early stages of growth plants in variants treated with the addition of this supplement show preferential root growth at the expense of aboveground biomass.

FIG. 7 “Height of mustard plants on neutral fluvisol with addition of supplement—17 days of growth” and Graph 8 “Length of mustard root on neutral fluvisol with addition—17 days of growth” show that an auxin-like effect has a supplement containing 100 wt % of depolymerized residue after dry distillation of wood at temperatures up to 300° C. also on neutral fluvisol, more significant than in the previous case already with the addition of 1 wt % of supplement.

Supplement application leads to improved plant growth conditions in the period of climatic changes in normal soil conditions, especially with limited rainfall. Addition of a supplement containing 100 wt % of depolymerized residue after dry distillation of wood at temperatures up to 300° C. promotes the growth of a deeper and richer root system compared to the aboveground part of the plant, which means better access to water and nutrients for the plant even in climatically less favorable periods and at the same time this addition improves water retention in the soil. The lifespan of plants is not immediately threatened by a shorter periods of drought and the sustainability of their growth is preserved.

These facts also apply to basic grassing, grass carpet laying and other grassing techniques, as well as to other types of plants or agricultural crops.

The depolymerized residue after dry distillation of wood at temperatures up to 300° C. is a hydrophobic organic matter that allows to maintain a favourable relative humidity in the mixture and thus significantly reduce water consumption during the necessary irrigation. Methyl alcohol residues and phenylpropanoid derivatives already without alcohol groups, bound to partially depolymerized and carbonized cellulose, are readily available nutrients for bacteria living on the root system of plants, promoting their multiplication and gradual increase in the content of humic acids. Humic acids are the basic transporter of nutrients from the soil to the plant, they are the active component of humus and the described process can therefore be considered as a stimulation of plant growth even in the case of qualitatively higher soil types. Methyl alcohol residues and phenylpropanoid derivatives bound to partially depolymerized and carbonized cellulose also help plants better resist the negative effects of saline soils and tolerate residual salt in irrigation systems that are based on desalinated seawater.

It is preferable to use a supplement containing simultaneously depolymerised wood distillation residues at temperatures below 300° C. and at least one substance selected from a group consisting of compost, organic fertiliser, inorganic fertilisers, minerals, bacterial cultures of aerobic micro-organisms, carbohydrate-based bacterial nutrients, cellulase and amylase. In this layer of a mixture of soil and supplement and possibly other substances, cultivated plants, beginning with grass, can thus manage the supplied nutrients much better and at the same time consume a significantly smaller volume of water from irrigation. The amount of water needed for irrigation is reduced by up to 50% and fertilizer consumption by up to 30%.

### BRIEF DESCRIPTION OF DRAWINGS

FIG. 1 shows the length of the root of mustard seeds germinated in the extract from the depolymerised residue after dry distillation of wood at temperatures up to 300° C.

FIG. 2 shows the length of the hypocotyl of mustard seeds germinated in the extract from the depolymerised residue after dry distillation of wood at temperatures below 300° C.

FIG. 3 shows the proportion of germinated mustard seeds on acidic soil with the addition of depolymerised wood distillation residue below 300° C.

FIG. 4 shows the proportion of germinated mustard seeds in neutral soil with the addition of depolymerised residue after dry distillation of wood at temperatures below 300° C.

FIG. 5 shows the height of mustard plants on acid cambisol with the addition of depolymerised wood distillation residue at temperatures up to 300° C.—17 days of growth.

FIG. 6 shows the length of mustard root on acid cambisol with the addition of depolymerised wood distillation residue at temperatures up to 300° C.—17 days of growth.

FIG. 7 shows the height of mustard plants on neutral fluvisol with the addition of depolymerized residue after dry distillation of wood at temperatures up to 300° C.—17 days of growth.

FIG. 8 shows the length of mustard root on neutral fluvisol with the addition of depolymerized residue after dry distillation of wood at temperatures up to 300° C.—17 days of growth.

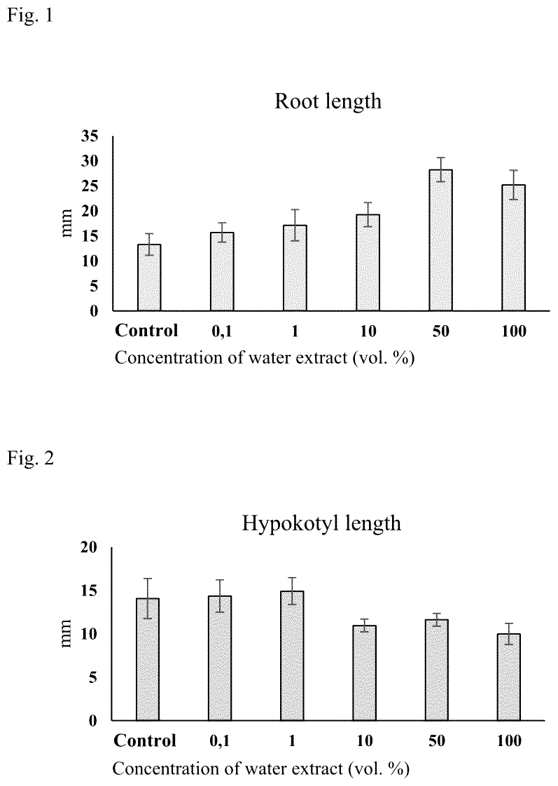

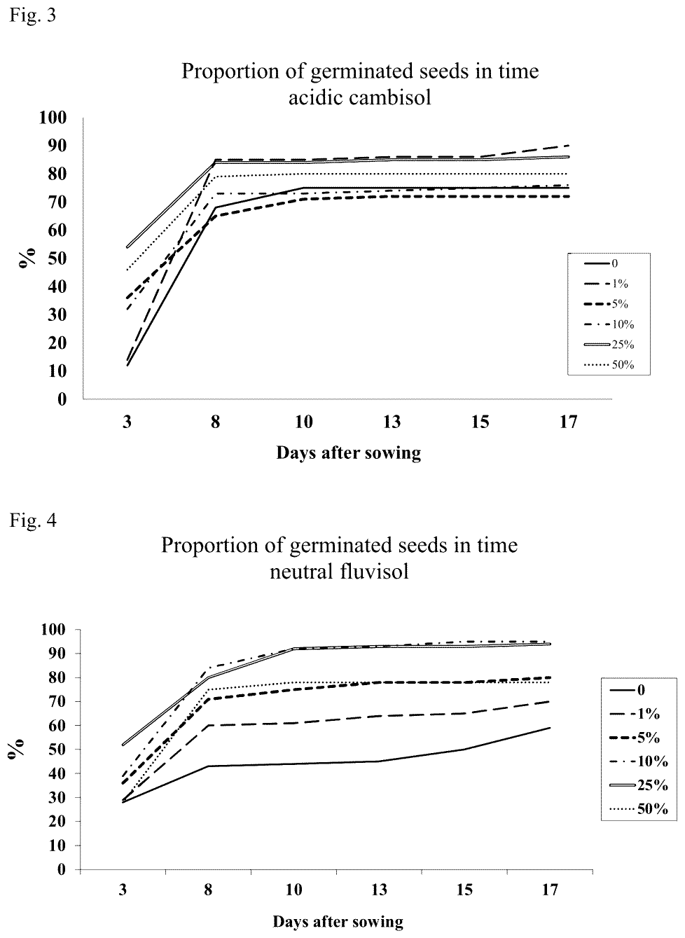

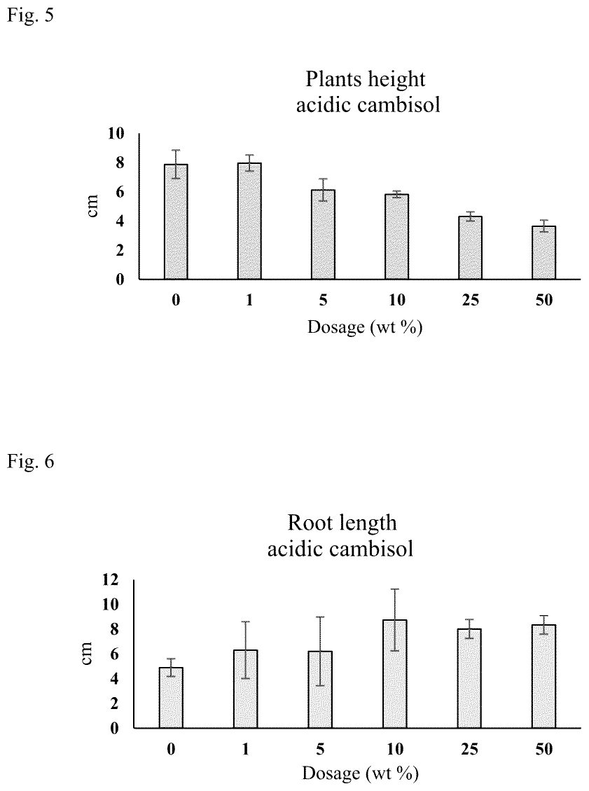

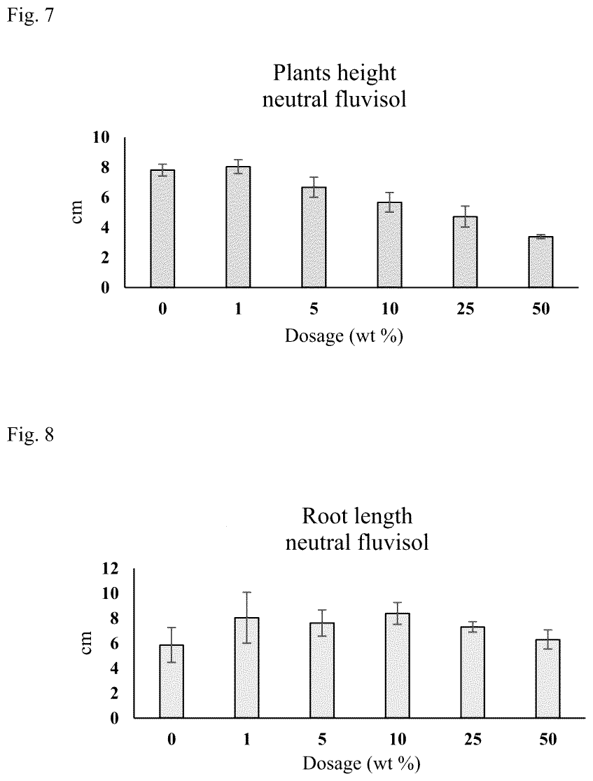

### DESCRIPTION OF EMBODIMENTS

### Examples

1. On 100 m² area of a field producing grass growing for football fields on the coast of Portugal was applied supplement containing 100 wt % of depolymerised residue after dry distillation of wood at a temperature not exceeding 300° C. It was incorporated into a 10 cm layer of this soil in the amount of 1 wt % related to the weight of the soil in this layer. On this area of application, the grass needed 30% less water for irrigation and 20% less fertilizer, while the vegetation was clearly color different, better resisted small salt drift carried by the wind from the sea on some days, and had a denser root system, which also reduced losses when removing and rolling grass carpets.
2. During reforestation after bark beetle calamity were monitored seedlings of oak, linden, maple, hornbeam and cherry in the total number of 3000 pcs, which were planted in soil mixtures with 1 wt % of supplement containing 100 wt % of depolymerised residue after dry distillation of wood at a temperature not exceeding 300° C. The control group consisted of another 3,000 seedlings of the same trees, planted in the same locality. Losses in the first year after planting were 26% in the control group, while supplement treated seedlings showed a loss of 12%.
3. On the golf course, one of the fairways was treated with a surface application corresponding to 1 wt % of supplement containing 100 wt % of depolymerised residue after dry distillation of wood at a temperature of up to 300° C., related to the top 5 cm layer of soil, the fairway sprinkled and verticulation carried out in order to incorporate the material into the soil as much as possible. This fairway needed 17% less water to irrigate than the other runways and 13% less fertilizer.
4. Under the 2 m high Thuja hedge, which had the root system and aboveground part damaged by construction work in the length of 20 m and the trees began to dry, was in the length of 10 m made grouting in the form of boreholes and they were filled with a mixture of garden substrate with 5 wt % of supplement containing 100 wt % of depolymerized residue from dry distillation of wood at a temperature not exceeding 300° C. in relation to the weight of substrate. The trees treated in this way were saved, while the rest of the hedge had to be replaced.
5. On a 100 m² strawberry field was a 10 m² treated with 56 kg of supplement containing 50 wt % of depolymerized residue after dry distillation of wood at temperatures up to 300° C. and 50 wt % of an organic fertiliser containing 1,5% of nitrogen, mixture incorporated into 20 cm depth of soil. The rest of the field was fertilized in the usual way with industrial fertilizer. The yield on the treated part of the field was 15% higher with normal rainfall.

### INDUSTRIAL APPLICABILITY

The invention can be used to improve the conditions of plant growth in forestry, agriculture, fruit growing, viticulture, gardening or grassing.

1. A supplement stimulating root system of plants, comprising:
a supplement that includes up to 100 wt % of a depolymerized residue after a dry distillation of wood at a temperature up to 300° C., used to enrich a soil layer to a depth of 5 to 30 cm or when planting trees and shrubs to a depth according to a size of the root ball, with 0.5 to 9.9 wt % of the depolymerised residue in relation to the weight of soil.

2. The supplement stimulating root system of plants according to claim 1, further comprising up to 90 wt % in relation to the supplement weight of at least one substance selected from a group comprising compost, organic fertiliser, inorganic fertilisers, minerals, bacterial cultures of aerobic micro-organisms, carbohydrate-based bacterial nutrients, cellulase and amylase, in relation to the weight of supplement.

3. The supplement stimulating root system of plants according to claim 1, wherein the depolymerized residue is an organic material and retains 2.8-3.4 times its weight of water.

4. A supplement for stimulating plants, comprising:
up to 100 wt % of a depolymerized residue after a dry distillation of wood at a temperature up to 300° C., and
up to 90 wt % in relation to the supplement weight of at least one substance selected from a group comprising compost, organic fertiliser, inorganic fertilisers, minerals, bacterial cultures of aerobic micro-organisms, carbohydrate-based bacterial nutrients, cellulase and amylase, in relation to the weight of the depolymerized residue.

5. The supplement for stimulating plants according to claim 4, wherein the depolymerized residue is a hydrophobic organic material and retains 2.8-3.4 times its weight of water.
